(19) United States
(12) Patent Application Publication
(10) Pub. No.: US 2019/0379557 A1
(43) Pub. Date: Dec. 12, 2019

(54) CROSS-PLATFORM DYNAMIC CONTENT BRIDGE

(71) Applicant: Safa Mahzari, San Diego, CA (US)

(72) Inventor: Safa Mahzari, San Diego, CA (US)

(21) Appl. No.: 16/004,857

(22) Filed: Jun. 11, 2018

(51) Int. Cl. H04L 12/46; G06F 9/54; H04L 29/08

(52) U.S. Cl. CPC H04L 12/462; H04L 67/26; H04L 67/306; G06F 9/542

(57) ABSTRACT

A method of bridging multiple environments includes: identifying a first user device associated with a first environment; retrieving bridge information associated with the first user device; and applying the bridge information to a second environment. A bridge device includes: a user identifier that determines a user identity based on at least one of user device information and user account information; an event identifier that recognizes events related to multiple bridged devices and systems; and a profile manager that maintains at least one profile associated with the user identity. A bridge system includes: multiple bridged systems including at least one of: an online system; offline system; virtual reality system; augmented reality system; and mixed reality system; and a bridge device that identifies events related to at least one of the bridged systems and applies customized features to at least one of the bridged systems based on the identified events.

### BACKGROUND

Many consumers may utilize various online and/or offline services or platforms, such as websites or other resources, virtual reality (VR), augmented reality (AR), and/or mixed reality (MR) systems, etc. In addition, such consumers may interact with various physical structures, locations, retailers, etc. (e.g., stores, advertising displays, real estate, etc.).

Current solutions do not allow consumer-users to link experiences, preferences, etc. across the various platforms.

In addition, current solutions fail to provide relevant information to the various platforms such that consumers are provided with a suitable customized experience.

Therefore there exists a need for a bridge that is able to collect, analyze, and distribute data among various platforms.

### SUMMARY

Some embodiments may include a bridge that may be able to link various associated environments, platforms, or resources provided by any number of systems and/or devices. The bridge may be an electronic device (or set of devices) that is able to communicate among the various associated elements. The bridge may be able to at least partly direct the operation of that associated elements in some embodiments.

The associated systems and/or devices may include any number of online systems, offline systems, virtual reality (VR) systems, augmented reality (AR) systems, mixed reality (MR) systems, and/or other appropriate systems and/or devices.

Online systems may include any systems and/or devices that are accessible via one or more networks. Such systems may include, for example, web sites, software applications, mobile apps, online gaming environments, etc. Offline systems may include any systems or devices that are directly accessible via user interaction or user device interaction. The VR/AR/MR systems may provide various immersive environments and may include online and/or offline systems and/or devices.

The various bridged environments may include custom or customizable features (e.g., avatar characteristics, multimedia content selections, etc.). Such customizable features may include a fixed number of options (e.g., a vehicle may include the options “sports car”, “SUV”, and “luxury sedan”). Such options may be linked to various manufacturers, dealers, etc. via the bridge. For instance, each particular vehicle manufacturer may select a particular model to designate for the available options. A device or system that is linked to a particular vehicle manufacturer may automatically indicate a preference that may then be applied across other environments. For instance, a user device may check in at a dealer. The next time the user device launches a gaming environment, the available vehicles may be associated with those available at the dealer.

The bridge may identify events across the bridged environments. Such events may include, for instance, user device logins to the environments, access of an online resource, etc. Events may also include various results, such as an advertisement impression, a purchase, completion of a game objective, etc.

The identified events may be applied to one or more of the bridged environments. Thus, an event identified in a first environment may be applied to a second environment. For instance, a user may select a particular team in a sporting game, and the user may be presented with content or advertising related to the particular team when the user visits a bridged website.

Some embodiments may perform machine learning based on identified events and/or results. Such machine learning may be used to update various algorithms and/or operating parameters associated with the bridge and/or the bridged systems.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The exemplary features of the disclosure are set forth in the appended claims. However, for purpose of explanation, several embodiments are illustrated in the following drawings.

FIG. 1 illustrates a schematic block diagram of a bridged system according to an exemplary embodiment;

FIG. 2 illustrates a schematic block diagram of a bridge device included in the system of FIG. 1;

FIG. 3 illustrates a schematic block diagram of an example hardware architecture used by the system of FIG. 1;

FIG. 4 illustrates a data structure diagram of various elements used by the system of FIG. 1;

FIG. 5 illustrates a flow chart of an exemplary process that links to additional bridge devices or systems;

FIG. 6 illustrates a flow chart of an exemplary process that customizes environmental features based on bridged feedback;

FIG. 7 illustrates a flow chart of an exemplary process that identifies and manages events within a bridged system of some embodiments;

FIG. 8 illustrates a flow chart of an exemplary process that identifies and applies custom features using a stock keeping unit (SKU) approach;

FIG. 9 illustrates a flow chart of an exemplary process that performs heuristic learning based on events within a bridged system of some embodiments;

FIG. 10 illustrates a message flow diagram of an exemplary communication algorithm used by the system of FIG. 1; and

FIG. 11 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a cross-platform dynamic content bridge.

A first exemplary embodiment provides an automated method of bridging multiple environments, the method comprising: identifying a first user device associated with a first environment; retrieving bridge information associated with the first user device; and applying the bridge information to a second environment.

A second exemplary embodiment provides a bridge device comprising: a user identifier that determines a user identity based on at least one of user device information and user account information; an event identifier that recognizes events related to a plurality of bridged devices and systems; and a profile manager that maintains at least one profile associated with the user identity.

A third exemplary embodiment provides a bridge system comprising: a plurality of bridged systems comprising at least one of: an online system; an offline system; a virtual reality (VR) system; an augmented reality (AR) system; and a mixed reality (MR) system; and a bridge device that identifies events related to at least one of the bridged systems and applies customized features to at least one of the bridged systems based on the identified events.

Several more detailed embodiments are described in the sections below. Section I provides a description of various hardware architectures used by some embodiments. Section II then describes methods of operation used by some embodiments. Next, Section III describes various use cases provided by some embodiments. Lastly, Section IV describes a computer system which implements some of the embodiments.

### I. Hardware Architecture

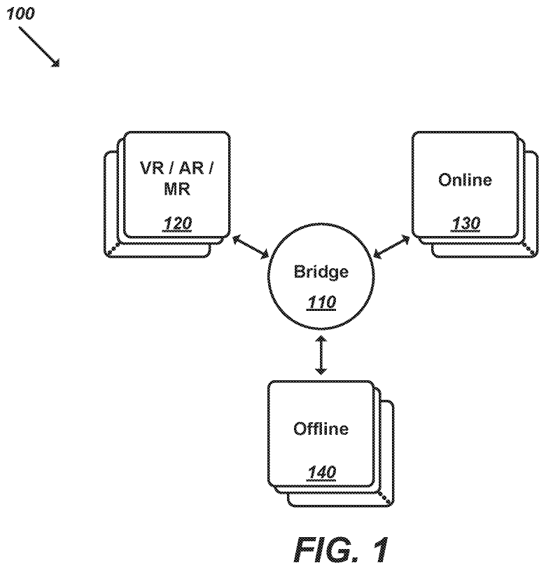

FIG. 1 illustrates a schematic block diagram of a bridged system 100 according to an exemplary embodiment. As shown, the system may include a bridge 110 of some embodiments, various VR/AR/MR systems 120, various online systems 130, and various offline systems 140.

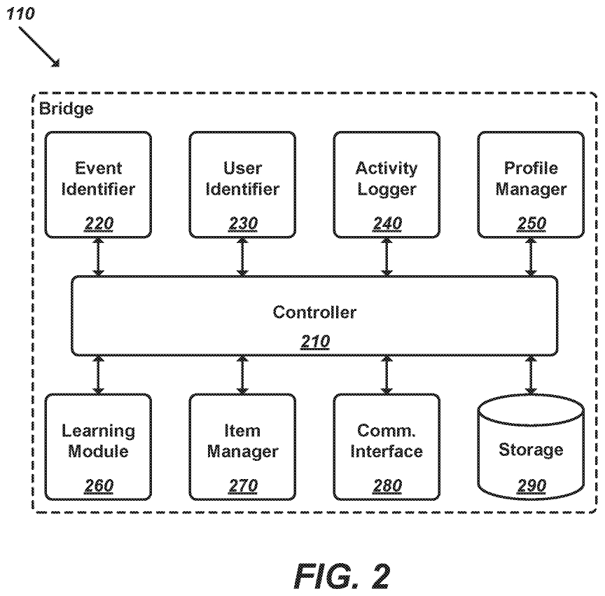

The bridge 110 may include one or more electronic devices that are able to execute instructions, process data, communicate across various available pathways, and/or otherwise facilitate interaction among the other system components 120-140. The bridge 110 will be described in more detail in reference to FIG. 2 below.

The VR/AR/MR systems 120 may include various electronic devices that are able to provide the appropriate interaction platform. Such systems may be able to communicate across one or more networks. The systems may be available for consumer use at various appropriate locations or facilities (e.g., home-based systems, location-specific systems, dedicated public or semi-public facilities, etc.).

The VR/AR/MR systems may include various combinations of online and/or offline elements. For instance, a virtual gaming environment may be implemented as an online system that is accessible via user-owned equipment. As another example, a user may go to a physical space to access an AR or MR system, where such systems may also include online components and/or be accessible to others at other physical spaces.

Throughout this disclosure, an “environment” or “platform” may refer to various features of a bridged system or device. Such features may include, for instance, an operating system, a type (e.g., “3D gaming”, “VR”, “AR”, “web page”, etc.), and/or other attributes that define various features and interfaces through which the bridge 110 of some embodiments may operate. Some environments may be accessed via application program interface (API). For instance, graphics or other custom features may be pushed to a server associated with the environment. Likewise, such information may be retrieved by the bridge and applied to other systems. Other data may also be pushed to the bridge from the platform, or the bridge may pull data from the platform.

The online systems 130 may include various online resources such as websites (e.g., entertainment sites, retail sites, discussion boards, etc.). Such systems may be accessed via a web browser, dedicated application, and/or other appropriate resources.

The offline systems 140 may include various resources that may be accessed by consumers at a particular location or facility. Such systems may be associated with complementary or integrated online systems 130. For instance, a retailer may have a website that serves as an online system and a number of store locations that may each serve as an offline system instantiation 140. The offline systems may include, for instance, advertising kiosks, point of sale terminals, etc.

FIG. 2 illustrates a schematic block diagram of bridge device 110. As shown, the bridge may include a controller 210, an event identifier 220, a user identifier 230, an activity logger 240, a profile manager 250, a learning module 260, an item manager 270, a communication interface 280, and a storage 290.

The controller 210 may be able to execute instructions and/or otherwise process data. The controller may at least partly direct the operations of some or all of the other components 220-290 of the bridge 110.

The event identifier 220 may recognize, detect, and/or otherwise identify events related to components of system 100. Such events may include user events (e.g., a user travels to a location, a user accesses a website, a sale or order is made, etc.), system or device events (e.g., a VR system or gaming platform may update available avatars or other custom features, an external system may request information related to a user, etc.), and/or bridge events (e.g., user profile updates based on user activity, algorithm updates based on heuristic learning, etc.).

The user identifier 230 may recognize, identify, authenticate, and/or validate a user identity. Such identities may be unique to each user, each user device, etc. Identities may be linked across different platforms by the bridge 110. For instance, a user may login to a first website using an email address. The user may access a VR system using a different username. The bridge may associate the email address with the username.

The activity logger 240 may record various events. Events may be logged in multiple ways across multiple platforms with multiple associations. For instance, a consumer may visit a retail location. Such an action may be logged as one or more consumer-user events (e.g., “check in”, “purchase”, etc.) and/or one or more retailer-user events (e.g., “visit”, “sale”, etc.).

The profile manager 250 may manage various user and/or platform profiles. Such profiles may be associated with consumers, retailers, websites, physical locations, etc. Different profiles may include different specific elements. In general, each profile may include a unique user identification, a listing of platforms associated with a user, etc. Profiles may include lists of associated users (e.g., a specific online platform profile may include a list of currently active users, a list of former users, a list of new users, etc.).

The learning module 260 may be able to analyze activity, user profile information, etc. in order to generate and/or modify algorithms associated with the bridge 110. The learning module 260 may also provide analysis to other elements of the bridge 110 and/or other elements of the system 100.

The item manager 270 may compile, index, retrieve, and/or otherwise manage customizable items associated with some embodiments. Such items may be associated with various platforms. For instance, a virtual gaming platform may include options associated with a player (e.g., attire, equipment, etc.). Such options may be associated with a list of available items for each specific option. Thus, if the player is associated with a vehicle in the gaming environment, the item manager may include a number of items associated with an option. Such associated items may range from generic (e.g., bicycle, car, truck, etc.) to specific (e.g., an automobile of a particular year, make, model, color, etc.).

The communication interface 280 may be able to communicate across various wired and/or wireless communication pathways. Such pathways may include one or more networks.

The storage 290 may be able to store instructions and/or data. The contents of the storage may be made available to other systems and/or devices via a resource such as an API.

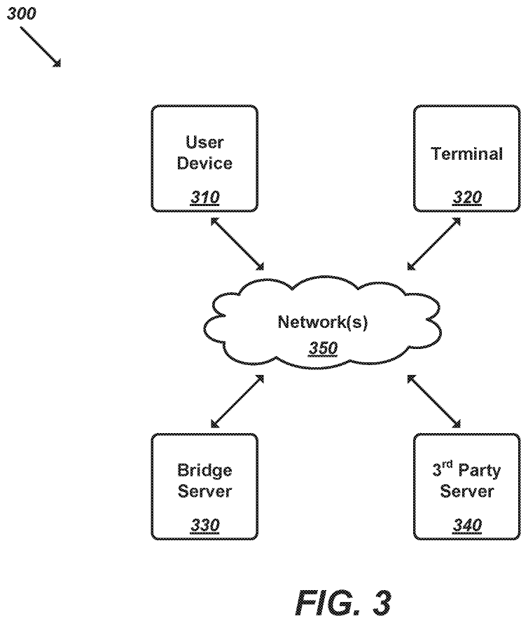

FIG. 3 illustrates a schematic block diagram of an example hardware architecture 300 used by the system 100. As shown, the system may include a number of user devices 310, a number of terminals 320, a bridge server 330, third party servers 340, and one or more networks 350 or other communication pathways. The devices described in reference to system 300 may be used to implement system 100.

Each user device 310 may be a device such as a smartphone, tablet, personal computer, laptop, gaming device, television, wearable device, camera, smart home appliance, Internet of things (IoT) device, server, etc. Each device may be associated with one or more users. The user device may typically be able to interact with other system components via network 350, interact with a user via a physical interface, and/or perform other functions associated with such devices.

Each terminal 320 may be a device located at an establishment associated with a VR/AR/MR system 120, online system 130, and/or offline system 140. Examples of terminals include advertising kiosks, vending machines, point of sale devices or registers, location sensors, etc. Terminals 320 may collect consumer interaction information. Such information may be made available to the bridge server 330 over networks 350. In some cases, data may be downloaded from the terminals 320 and transmitted over the network 350 using a secondary device (e.g., a user device).

The bridge server 330 may include one or more electronic devices that are able to implement the bridge device 110 described above.

Each third party server 340 may be an electronic device (or set of devices) that implements a VR/AR/MR system 120 or other online system 130. In some cases, the server(s) 340 may be accessible via an API.

The networks 350 may include various wired and/or wireless communication pathways (e.g., cellular, Wi-Fi, Bluetooth, radio, the Internet, etc.).

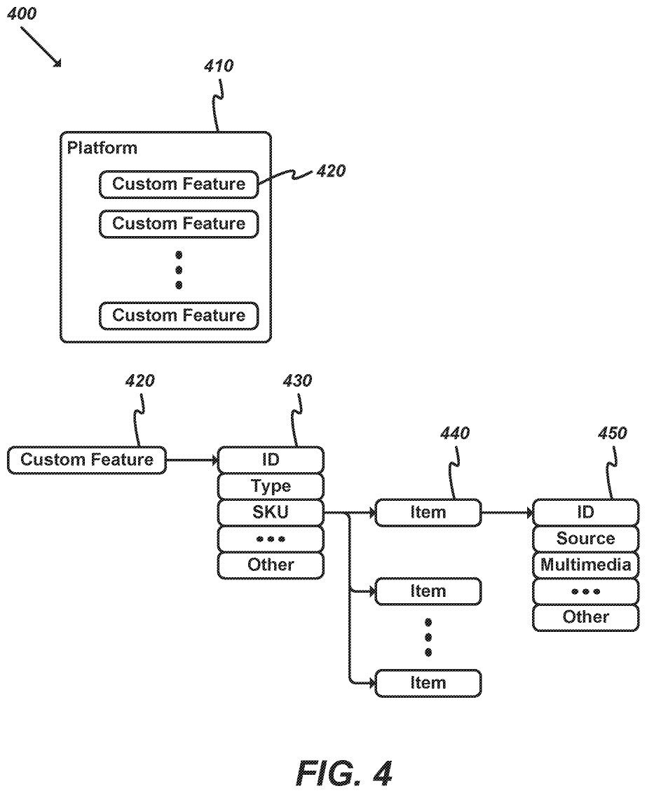

FIG. 4 illustrates a data structure diagram 400 of various elements used by the system 100. In this example, the data structures may include a platform element 410 having a number of custom feature 420 sub-elements. The platform element 410 may be associated with an environment such as a 3D gaming world. The custom features 420 may reference customized and/or customizable elements available in the environment (e.g., attire, equipment, visual and/or sonic features associated with an avatar, etc.).

The custom feature elements may include sub-elements 430 such as a unique identifier, type, SKU, etc. Other elements may include similar sub-elements. Each SKU sub-element may reference a limited number of potential items 440 in order to maximize computing efficiency and storage space. For instance, a vehicle in the gaming world may be limited to fewer than ten SKU items (e.g., sports car, truck, motorcycle, minivan, SUV, etc.).

Each item 440 may include various sub-items 450, such as a unique identifier, source of the item (e.g., a car manufacturer may supply or otherwise endorse various representations of their vehicles), multimedia associated with the item (e.g., graphics, audio, etc.), and/or other appropriate elements.

One of ordinary skill in the art will recognize that the above-referenced systems, devices, and data structures are presented for exemplary purposes and different embodiments may be implemented in various different ways without departing from the scope of the disclosure. For instance, different embodiments may include different specific devices, numbers of devices, and/or communication pathways among devices.

### II. Methods of Operation

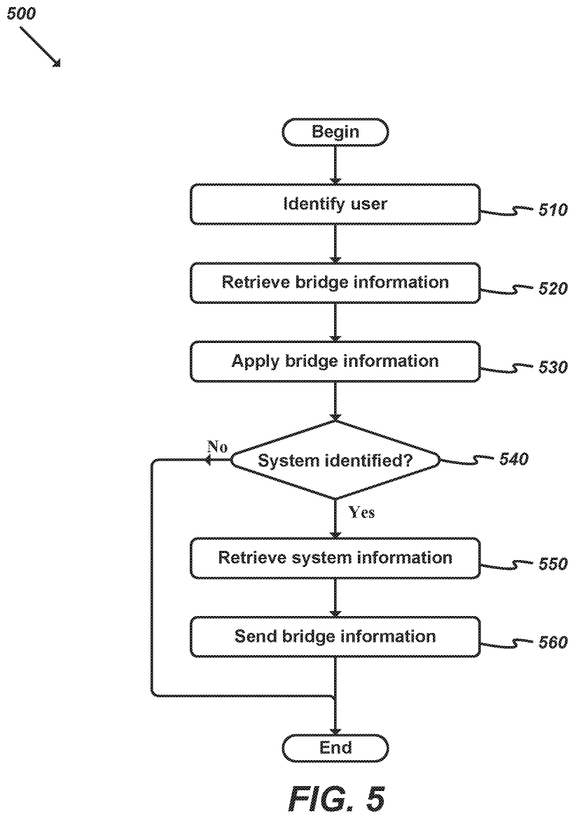

FIG. 5 illustrates a flow chart of an exemplary process 500 that links to additional bridge devices or systems. The process may begin, for instance, when a user interacts with a bridged system or device. The process may be executed by a resource such as user device 310, terminal 320, and/or bridge 330.

As shown, the process may identify (at 510) the user associated with the interaction. Such an identification may be made in various appropriate ways (e.g., a user may log in to an application or web site on a user device, the user device may provide identifying information to another device via Bluetooth or Wi-Fi, etc.).

Next, the process may retrieve (at 520) bridge information. Such information may include, for instance, information associated with the user, user device, terminal, etc. The process may then apply (at 530) the bridge information. Thus, for instance, an application associated with the bridge system may broadcast bridge information to other devices in the area, the information may be applied to the application itself (e.g., by updating content or user interface features based on bridged data from another system), etc.

The process may then determine (at 540) whether a new system has been identified. Such a determination may be made in various appropriate ways. For instance, a system beacon or identification may be received (e.g., via Bluetooth) and compared to a list of previously associated systems. In some cases, a system may be identified based on a location determined by a user device (e.g., a global positioning system feature may be used to trigger identification when a user is within an area).

If the process determines (at 540) that no new system has been identified, the process may end. If the process determines (at 540) that a new system has been identified, the process may retrieve (at 550) information associated with the system. Such information may include, for example, reference information (e.g., if a user visits a car dealer, a particular make of automobile may be recorded for future use), live content (e.g., a user interface may be updated to reflect attributes of the new system), etc.

Next, the process may send (at 560) bridge information to the newly identified system and then may end. Such information may include various features or attributes associated with the user. Thus, to continue a car dealership example, when the user passes an advertising display at the dealership, the displayed content may be customized for the user (e.g., pickup truck content may be displayed rather than luxury sedan content, a music system may play songs or artists that appeal to the user, etc.).

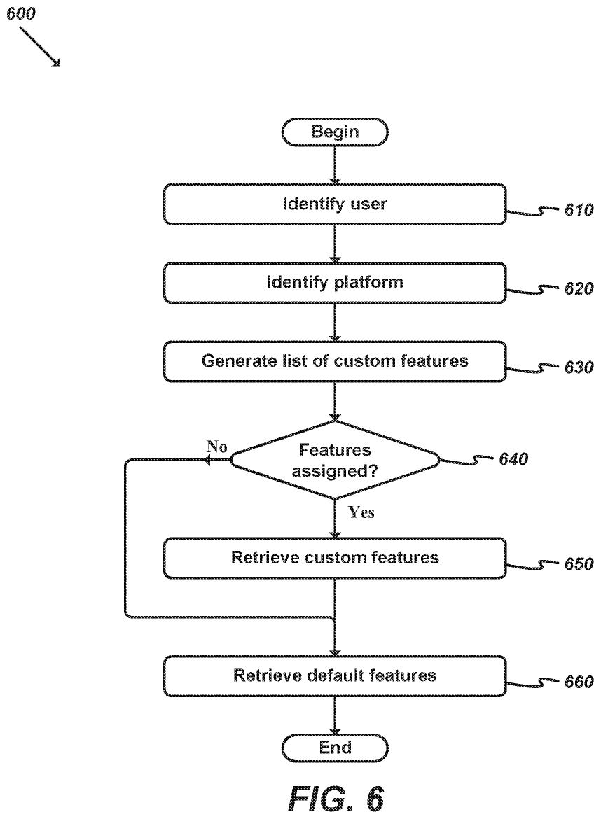

FIG. 6 illustrates a flow chart of an exemplary process 600 that customizes environmental features based on bridged feedback. The process may begin, for instance, when a user activates a platform device (e.g., a gaming system). The process may be executed by a resource such as user device 310, terminal 320, and/or bridge 330.

As shown, the process may identify (at 610) the user. Such an identification may be made in various appropriate ways (e.g., a user may log in to an application or web site on a user device, the user device may provide identifying information to another device via Bluetooth or Wi-Fi, etc.).

Next, the process may identify (at 620) the platform. Such identification may be made by the bridge 330 based on identifying information received from the platform system. For example, the identification may specify a particular gaming system, environmental attributes, and/or other features associated with the platform.

The process may then generate (at 630) a list of custom features associated with the platform. For instance, a particular gaming environment may allow a user to customize clothing, a vehicle, and facial features.

Next, the process may determine (at 640) whether the custom features have been assigned to specific items. Items may be assigned to features based on, for example, user selection, event history, profile information, etc. If the process determines (at 640) that the features have been assigned, the process may retrieve (at 650) the custom features.

After retrieving (at 650) the custom features, or after determining (at 640) that the features have not been assigned, the process may retrieve (at 660) default features and then may end. Such custom and default features may be applied to the platform environment, as appropriate (e.g., a custom vehicle may only be applied to the gaming platform when the vehicle is visible to the user's avatar).

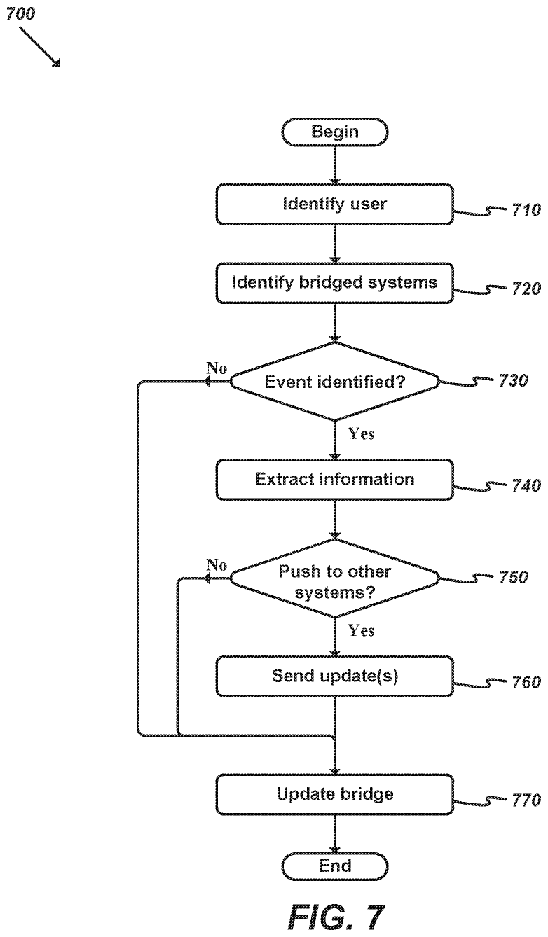

FIG. 7 illustrates a flow chart of an exemplary process 700 that identifies and manages events within a bridged system of some embodiments. The process may begin, for instance, when a user launches an application of some embodiments, when a new interaction is detected, etc. The process may be executed by a resource such as user device 310, terminal 320, and/or bridge 330.

As shown, the process may identify (at 710) the user. Such an identification may be made in various appropriate ways (e.g., a user may log in to an application or web site on a user device, the user device may provide identifying information to another device via Bluetooth or Wi-Fi, etc.).

Next, the process may identify (at 720) bridged systems associated with the user (e.g., gaming environments, websites, retailers, etc.).

The process may then determine (at 730) whether an event has been identified. Such a determination may be made based on various relevant criteria. For instance, events may be defined by certain types of selections or interactions. Various events will be described in Section III below. Events may be identified in real time in some cases (e.g., when a user visits an establishment) or based on previously recorded activity (e.g., sales information may be downloaded from a store's terminals every evening). A sub-set of identified events may be referred to as “results”. Such events may include a purchase, access of a provided link, use of a suggested item, etc.

If the process determines (at 730) that an event has been identified, the process may extract (at 740) information associated with the event. Such information may include, for instance, user identification, user device information, terminal information, online or offline system information, etc.

Next, the process may determine (at 750) whether push notifications should be sent to any bridged systems. Such a determination may be made based on various relevant criteria (e.g., user location, last system interaction, etc.). If the process determines (at 750) that other systems should be notified, the process may send (at 760) any updates based on the event.

After determining (at 750) that no push notifications are needed, after sending (at 760) any updates, or if the process determines (at 730) that no event has been identified, the process may update (at 770) the bridge. Such updates may include updates to the user profile, activity log, lists of selected items, lists of bridged systems, etc. In some cases, the update may indicate that no events were identified.

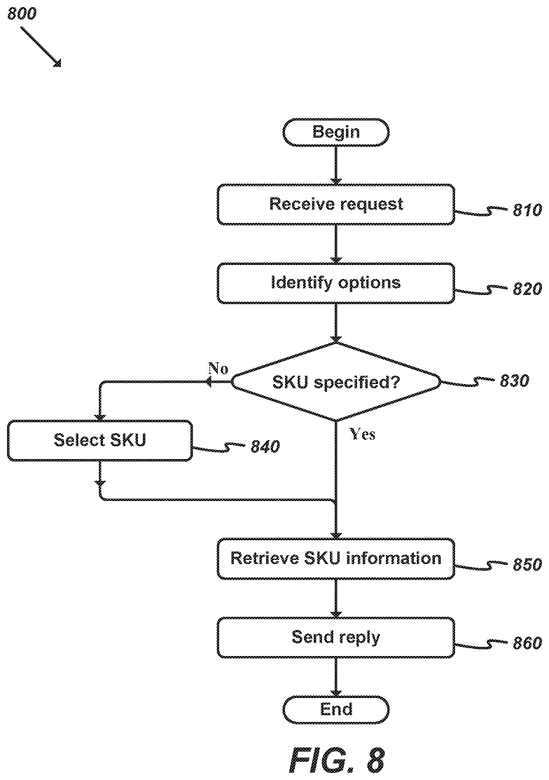

FIG. 8 illustrates a flow chart of an exemplary process 800 that identifies and applies custom features using a stock keeping unit (SKU) approach. The process may begin, for instance, when process 600 retrieves custom features. Process 800 may be executed by a resource such as user device 310, terminal 320, and/or bridge 330.

As shown, the process may receive (at 810) a request for an item. Alternatively, the process may generate the request itself. Next, the process may identify (at 820) options associated with the item (e.g., a list of SKUs).

The process may then determine (at 830) whether a SKU has been specified for the item (i.e., whether a feature is associated with a bridge customization). If the process determines (at 830) that no SKU has been specified by the request, the process may select (at 840) a SKU. Such a selection may be based on default values, tendencies of the user, current selection made by the user, etc.

After determining (at 830) that the SKU was specified or after selecting (at 840) the SKU, the process may retrieve (at 850) SKU information. Such information may include the various elements described above in reference to data structure diagram 400.

Next, the process may send (at 860) a reply to the request and then may end. If the request was self-generated, the reply may simply be applied at the appropriate device. The reply may include necessary information related to the SKU, which may depend on the system or device making the request. For instance, a request from a 3D virtual environment may generate a reply that includes 3D modeling parameters, graphics, audio data, etc. In contrast, a request from a sales display may generate a reply than includes a static image only.

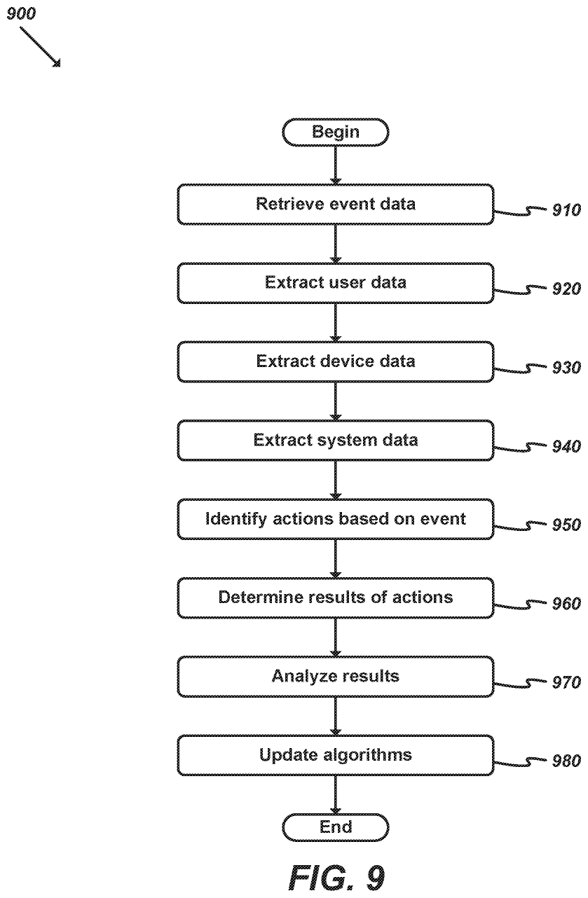

FIG. 9 illustrates a flow chart of an exemplary process 900 that performs heuristic learning based on events within a bridged system of some embodiments. The process may be executed at regular intervals, based on a number of events since a last update, and/or other appropriate criteria. The process may be executed by a resource such as user device 310, terminal 320, and/or bridge 330.

As shown, the process may retrieve (at #9010) event data. Such data may be retrieved from a resource such as storage 290.

Next, the process may extract (at 920) user data for each event. User data may include information related to specific users. Such data may also be anonymously grouped in various ways (e.g., all users that played a particular game console within the last week may be included in a group, all users who made a purchase at a particular website may be included in a group, etc.).

The process may then extract (at 930) device data for each event. The device data may include specific attributes of a device (e.g., model, type, revision, etc.) as well as software attributes (e.g., operating system version, web browser, etc.). As above, the device data may be grouped in various ways (e.g., by manufacturer, by model, by operating system, etc.).

Process 900 may then extract (at 940) system data for each event. Such system data may include, for instance, a web address, hardware information, system type information, etc. Such data may be grouped in various ways.

Next, the process may identify (at 950) any actions based on the event. Such actions may be related to system-side actions. For instance, a website may display an advertisement or play a certain song when a user visits the site. As another example, a user may be presented with specific content or options within a gaming environment.

The process may then determine (at 960) any results of the actions. Such results may include, for instance, length of game play, purchase information, etc. Thus, for instance, if an advertisement was displayed on a website, the result may be whether the user clicked the ad or not.

Process 900 may then analyze (at 970) the results. Such analysis may involve grouping users, devices, systems, actions, etc. and attempting to correlate those variables to the identified results. Such correlation may include, for instance, statistical analysis.

Next, the process may update (at 980) various algorithms and/or parameters based on the analysis and then may end. Such updates may be related to particular users (e.g., a first user may extend game play based on certain music selections and the system may be more likely to make those selections). Updates may be related to groups of users (e.g., if users of a particular device are more likely to make a purchase when a website uses a particular offer).

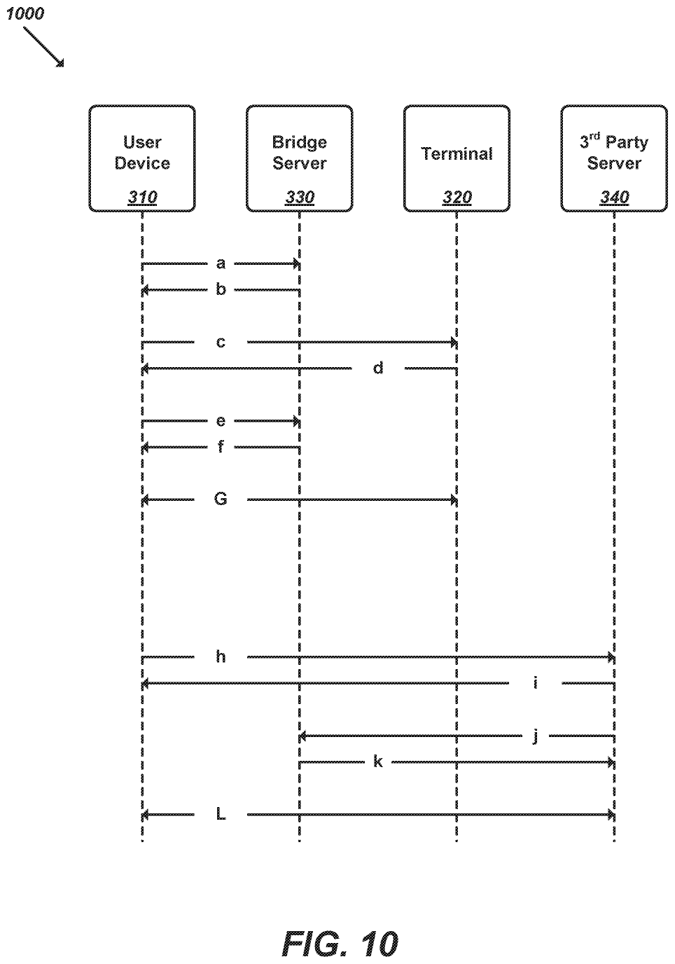

FIG. 10 illustrates a message flow diagram 1000 of an exemplary communication algorithm used by the system 100. The algorithm may begin, for instance, when a user launches an application of some embodiments, when a user powers on a device, etc. The algorithm may be executed by a resource such as user device 310, terminal 320, and/or bridge 330.

As shown, in a first example the user device 310 may send a message ‘a’ to the bridge 330. Such a message may include, for instance, authentication information (e.g., username, account information, device information, etc.). The bridge may authenticate the user, the device, and/or otherwise identify the source of the message.

The bridge 330 may send a response message ‘b’. Such a message may include, for instance, updates (e.g., application updates, parameter updates, etc.). Such a combination of messages may generate an active “session” of the user device 310 on a bridge system.

Next, the user device 310 may send a message ‘c’ to a terminal 320. The message may be similar to a beacon that is transmitted at regular intervals and includes identifying information for the bridge system (e.g., user ID, device ID, etc.). The terminal 320 may send a response message ‘d’. The response may include bridge information related to the terminal (e.g., system ID, terminal ID, etc.). The terminal may be associated with an online system or offline system.

Next, the user device 310 may send a message ‘e’ to the bridge 330. Such a message may include information related to the terminal. The bridge may response with message ‘f’. Such a message may include bridge information related to the terminal system, the user, the user device, etc.

The user device 310 and terminal 320 may then establish a bridged channel ‘G’. The bridged channel may allow for bridge customizations of the user experience, logging of events, etc. The user device 310 and/or terminal 320 may send a summary message (not shown) to the bridge 330 after the session is completed and the channel ‘G’ is closed. Alternatively, the bridge 330 may directly monitor some or all of the communication across channel ‘G’.

In a second example, the user device 310 and bridge 330 may again send message ‘a’ and message ‘b’ to generate an active “session” of the user device 310 on a bridge system.

Next, the user device 310 may send a message ‘h’ to a third party server 340 such as a gaming server. The message may be sent as part of an authentication process and may include identifying information for the bridge system (e.g., user ID, device ID, etc.). The third party server 340 may send a response message ‘i’. The response may include bridge information related to the system (e.g., system ID, feature list, etc.). The server may be associated with an online system.

The third party server 340 may send a message ‘j’ to the bridge 330. Such a message may include information related to the system, the user, the user device, etc. The bridge may send a response message ‘k’ to the server 340. Such a message may include bridge information related to the terminal system, the user, the user device, etc.

The user device 310 and server 340 may then establish a bridged channel ‘L’. The bridged channel may allow for bridge customizations of the user experience, logging of events, etc. The user device 310 and/or server 340 may send a summary message (not shown) to the bridge 330 after the session is completed and the channel ‘L’ is closed. Alternatively, the bridge 330 may directly monitor some or all of the communication across channel ‘L’.

One of ordinary skill in the art will recognize that processes and algorithms 500-1000 are presented for exemplary purposes and may be implemented in various different ways without departing from the scope of the disclosure. For instance, the various operations may be performed in different orders. As another example, some operations may be omitted and/or other operations may be included. Each process may be divided into multiple sub-processes and/or multiple processes may be combined to form a single macro process. In addition, the processes (or portions thereof) may be performed iteratively and/or based on some performance criteria.

### III. Example Use Cases

In a first example, a video game may be connected to a mobile device application. The video game may include a customizable character (e.g., a mobile phone associated with the character may be chosen). The mobile application may be developed by the manufacturer of the game console or game publisher. The user may log in to the gaming system and the mobile application using the same credentials. Data may be pushed by the bridge or pulled by the mobile device or video game.

A first event may occur when the player plays the video game for the first time, where a default mobile phone may be displayed. The bridge may identify the event and save game settings and/or preferences.

A second event may occur when the player downloads the mobile application and logs in using the matching credentials. The bridge may detect the mobile device type and save that information for later use.

A third event may occur when the player logs into the video game at a later time. The bridge may push the detected mobile device type to the video game, which may now display the detected device during game play.

In a second example, a video game may be linked to digital advertising. The video game may include options where players can select a car and track and race against other participants. The digital advertising may be implemented by a website with banner advertisements.

A first event may occur when a player plays the video game on a tablet device, selecting a green SUV and a dirt track. The bridge may identify and log the event.

A second event may occur when the player visits the website using the same tablet. The bridge may determine if the site visitor has a profile. If a profile is found, information may be pushed to the advertising platform. The website may then display a SKU-based advertisement related to off-roading and camping (as opposed to a SKU related to a luxury sedan in a downtown environment, or a SKU related to a sports car on a race track).

In a third example, an open house tour may be connected to various social media platforms. The open house tour may be an AR system. The social media platform may include profile information linked to a social media site or tied to a person account (e.g., an email or phone number).

A first event may occur when a person walks into a model home tour that is aided by an AR headset. A second event may occur when the person provides identifying information to start the tour (e.g., name, email, phone number, etc.). The bridge may identify the event and pull information from the social media platform. For instance, the bridge may check email address and phone number against a bridge profile.

A third event may occur when the person starts the home tour and the AR headset changes lighting, TV programming, audio, items shown in the refrigerator, etc. based on the person's preferences. In this example, such preferences may be at least partially determined by analyzing “likes”, comments, follows, etc. associated with the social media platform(s).

A fourth event may occur when the person completes a survey following the tour. The bridge may update preferences based on the survey responses, where such updates may apply specifically to the user and/or groups of users with similar profile information.

Such survey information (and/or other result information such as a purchase or failure to purchase) may be stored and analyzed by the bridge system, using a process such as process 900 described above in order to determine any similarities in the AR experience that may be related to a particular result.

In a fourth example, a retail establishment may be connected to a mobile phone.

A first event may occur when a customer purchases a particular branded item. The bridge may save such purchase information (e.g., customer ID, item purchases, date, retail location, etc.).

A second event may occur when the customer downloads an application associated with the particular brand and logs in to the application via the mobile phone. In response, the bridge may save game settings or preferences associated with the application (e.g., installation device, operating system, etc.).

A third event may occur when the customers enters a shopping mall having a store dedicated to the particular brand. Location information may be sent from the phone to the bridge. Such location information may be generated by the phone itself (e.g., using GPS) or based on interaction with the bridge may, in turn, push a message to the mobile phone. Such a push message may include, for instance, the location of the store, sale information, coupons or other offers, etc.

Other examples include linking one video game to another. For instance, a user may complete a shooting game at maximum difficulty. A different shooting game may recommend a higher difficulty level than is typical. As another example, a user may have spent three hundred hours playing a first racing game. When the user loads a second racing game, the user may be granted various rewards and/or load as many relevant game preferences as possible.

As another example, a video game may be bridged to a website or advertising platform. For instance, if a user plays a football game as a particular team, players from that team may be included in a banner ad for an updated version of the football game.

A mobile application may receive a user login related to shopping for apparel. The login credentials may match a profile found on the bridge of some embodiments. The bridge may send information regarding height, weight, clothing size, shoe size, preferences (e.g., fitted, standard, relaxed fit, etc.), etc. The mobile application may provide a selection of items tailored to the profile information (e.g., showing shoes available in a particular size, favoring certain styles of shirt, etc.). Non-tailored items may also be included (and/or otherwise available, such as by user selection). In addition, items that have already been purchased by the user through bridged systems may be automatically excluded. Further, stylistic recommendations may be included (e.g., “people who bought the same boots as you tended to also buy this style of jeans”). In addition, users may be able to update their profile (e.g., by changing a size) and the updates may be applied to the bridge profile (automatically or based on some criteria, such as user selection or approval).

A business may interact with a software as a service vendor. The software product may be connected to the bridge of some embodiments. The bridge may import settings enforced by entities such as regulators, human resources departments, etc. Some or all of the software product settings and preferences may be configured to match. Notifications or alerts may be provided under various scenarios. For instance, if some necessary settings or preferences are not specified by the bridge profile(s), a notification may be sent to an administrator-user (and/or other appropriate entities) indicating that elements are missing and the vendor is unable to complete the request. Similarly, if a user attempts to change settings such that the settings conflict with bridge information, notifications, alerts, and/or warnings may be sent to various appropriate parties.

### IV. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

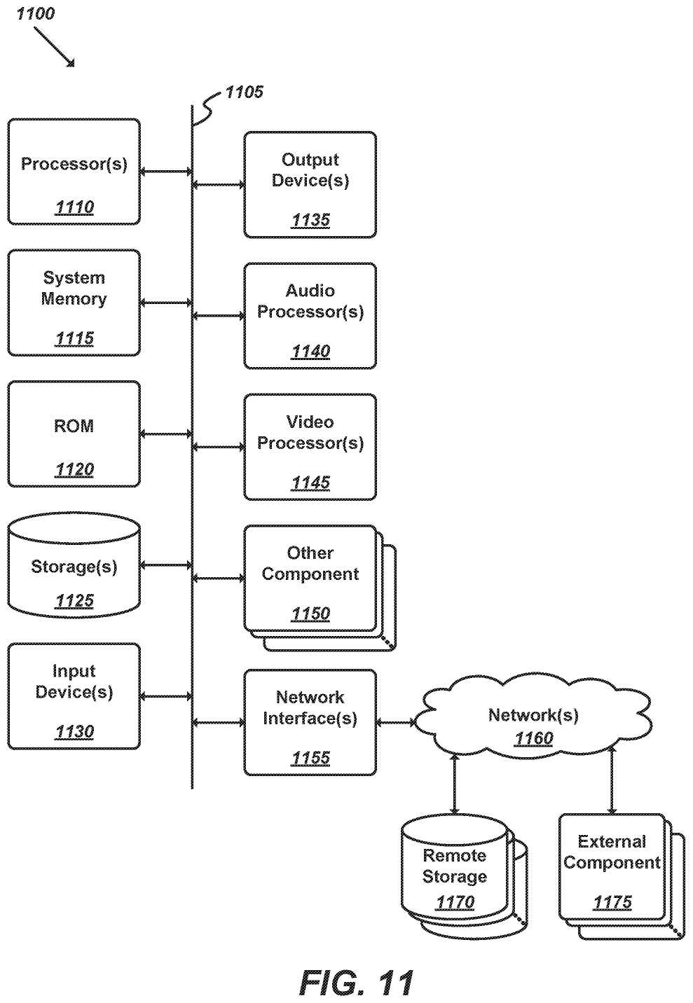

FIG. 11 illustrates a schematic block diagram of an exemplary computer system 1100 used to implement some embodiments. For example, the system described above in reference to FIG. 1-FIG. 4 may be at least partially implemented using computer system 1100. As another example, the processes described in reference to FIG. 5-FIG. 10 may be at least partially implemented using sets of instructions that are executed using computer system 1100.

Computer system 1100 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 1100 may include at least one communication bus 1105, one or more processors 1110, a system memory 1115, a read-only memory (ROM) 1120, permanent storage devices 1125, input devices 1130, output devices 1135, audio processors 1140, video processors 1145, various other components 1150, and one or more network interfaces 1155.

Bus 1105 represents all communication pathways among the elements of computer system 1100. Such pathways may include wired, wireless, optical, and/or other appropriate communication pathways. For example, input devices 1130 and/or output devices 1135 may be coupled to the system 1100 using a wireless connection protocol or system.

The processor 1110 may, in order to execute the processes of some embodiments, retrieve instructions to execute and/or data to process from components such as system memory 1115, ROM 1120, and permanent storage device 1125. Such instructions and data may be passed over bus 1105.

System memory 1115 may be a volatile read-and-write memory, such as a random access memory (RAM). The system memory may store some of the instructions and data that the processor uses at runtime. The sets of instructions and/or data used to implement some embodiments may be stored in the system memory 1115, the permanent storage device 1125, and/or the read-only memory 1120. ROM 1120 may store static data and instructions that may be used by processor 1110 and/or other elements of the computer system.

Permanent storage device 1125 may be a read-and-write memory device. The permanent storage device may be a non-volatile memory unit that stores instructions and data even when computer system 1100 is off or unpowered. Computer system 1100 may use a removable storage device and/or a remote storage device as the permanent storage device.

Input devices 1130 may enable a user to communicate information to the computer system and/or manipulate various operations of the system. The input devices may include keyboards, cursor control devices, audio input devices and/or video input devices. Output devices 1135 may include printers, displays, audio devices, etc. Some or all of the input and/or output devices may be wirelessly or optically connected to the computer system 1100.

Audio processor 1140 may process and/or generate audio data and/or instructions. The audio processor may be able to receive audio data from an input device 1130 such as a microphone. The audio processor 1140 may be able to provide audio data to output devices 1140 such as a set of speakers. The audio data may include digital information and/or analog signals. The audio processor 1140 may be able to analyze and/or otherwise evaluate audio data (e.g., by determining qualities such as signal to noise ratio, dynamic range, etc.). In addition, the audio processor may perform various audio processing functions (e.g., equalization, compression, etc.).

The video processor 1145 (or graphics processing unit) may process and/or generate video data and/or instructions. The video processor may be able to receive video data from an input device 1130 such as a camera. The video processor 1145 may be able to provide video data to an output device 1140 such as a display. The video data may include digital information and/or analog signals. The video processor 1145 may be able to analyze and/or otherwise evaluate video data (e.g., by determining qualities such as resolution, frame rate, etc.). In addition, the video processor may perform various video processing functions (e.g., contrast adjustment or normalization, color adjustment, etc.). Furthermore, the video processor may be able to render graphic elements and/or video.

Other components 1150 may perform various other functions including providing storage, interfacing with external systems or components, etc.

Finally, as shown in FIG. 11, computer system 1100 may include one or more network interfaces 1155 that are able to connect to one or more networks 1160. For example, computer system 1100 may be coupled to a web server on the Internet such that a web browser executing on computer system 1100 may interact with the web server as a user interacts with an interface that operates in the web browser. Computer system 1100 may be able to access one or more remote storages 1170 and one or more external components 1175 through the network interface 1155 and network 1160. The network interface(s) 1155 may include one or more application programming interfaces (APIs) that may allow the computer system 1100 to access remote systems and/or storages and also may allow remote systems and/or storages to access computer system 1100 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 1100 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

I claim:

1. An automated method of bridging multiple environments, the method comprising:
identifying a first user device associated with a first environment;
retrieving bridge information associated with the first user device; and
applying the bridge information to a second environment.

2. The automated method of claim 1, wherein:
the first user device comprises at least one of a smartphone, personal computer, tablet, wearable device, game system, and virtual reality system,
the first environment comprises an operating system associated with the first user device,
the second environment is associated with a second user device comprising at least one of a smartphone, personal computer, tablet, wearable device, game system, and virtual reality system, and
the second environment comprises an operating system associated with the second user device.

3. The automated method of claim 2 further comprising:
identifying a third environment;
retrieving information associated with the third environment; and
applying the bridge information to the third environment.

4. The automated method of claim 3, wherein:
the third environment is associated with a third user device comprising at least one of a smartphone, personal computer, tablet, wearable device, game system, and virtual reality system, and
the third environment comprises an operating system associated with the third user device.

5. The automated method of claim 1, wherein the first environment comprises an online system and the second environment comprises an offline system.

6. The automated method of claim 1, wherein the bridge information comprises at least one of:
a user identifier,
a type,
a stock keeping unit (SKU) identifier,
a list of custom features,
a user profile, and
an activity log.

7. The automated method of claim 1, wherein the bridge information comprises at least one multimedia content item.

8. A bridge device comprising:
a user identifier that determines a user identity based on at least one of user device information and user account information;
an event identifier that recognizes events related to a plurality of bridged devices and systems; and
a profile manager that maintains at least one profile associated with the user identity.

9. The bridge device of claim 8 further comprising an activity logger that records events recognized by the event identifier.

10. The bridge device of claim 8, further comprising an item manager that handles items related to the user identity and at least one bridged device or system from the plurality of bridged devices and systems.

11. The bridge device of claim 10, wherein the item manager utilizes a limited number of stock keeping unit (SKU) identifiers for each item from among the items related to the user identity.

12. The bridge device of claim 8 further comprising a communication interface that pulls and pushes message data among the plurality of bridged devices and systems.

13. The bridge device of claim 12, wherein the event recognizer identifies an event on a first device or system from the plurality of bridged devices and systems and the communication interface pushes at least one message to a second device or system from the plurality of bridged devices and systems.

14. The bridge device of claim 8 further comprises a learning module that is able to analyze events and results of environmental interactions in order to update operating algorithms and parameters associated with the bridge device.

15. A bridge system comprising:
a plurality of bridged systems comprising at least one of:
an online system;
an offline system;
a virtual reality (VR) system;
an augmented reality (AR) system; and
a mixed reality (MR) system; and
a bridge device that identifies events related to at least one of the bridged systems and applies customized features to at least one of the bridged systems based on the identified events.

16. The bridge system of claim 15, wherein events identified on a particular bridged system are applied to at least one other bridged system.

17. The bridge system of claim 15, wherein the customized features include a set of customizable options and each option is associated with a pre-defined set of items.

18. The bridge system of claim 15, wherein the identified events comprise a set of results.

19. The bridge system of claim 18, wherein the bridge analyzes the identified events to determine relationships between the set of results and other identified events.

20. The bridge system of claim 19, wherein the relationships include statistical correlation information and the bridge device utilizes the statistical correlation information to update algorithms and parameters associated with event identification and application of customized features.
